(19) United States
(12) Patent Application Publication
(10) Pub. No.: US 2019/0129423 A1
(43) Pub. Date: May 2, 2019

(54) DYNAMIC IMPACT DETECTION

(71) Applicant: TEAL DRONES, INC., Salt Lake City, UT (US)

(72) Inventors: George Michael Matus, JR., Salt Lake City, UT (US); Shawn Ray Nageli, South Jordan, UT (US)

(21) Appl. No.: 16/170,883

(22) Filed: Oct. 25, 2018

Related U.S. Application Data
(60) Provisional application No. 62/577,341, filed on Oct. 26, 2017.

(51) Int. Cl. G05D 1/00; G05D 1/10; B64C 39/02

(52) U.S. Cl. CPC G05D 1/0088; G06F 16/285; B64C 39/024; G05D 1/101

(57) ABSTRACT

A rotor-based remote flying vehicle includes one or more sensors. The one or more sensors are configured to generate data corresponding to an impact of at least one rotor of the rotor-based remote flying vehicle. The generated sensor data is accessed by a processing unit of the rotor-based remote flying vehicle. The processing unit is configured to characterize a detected impact by identifying at least one of an object type with which contact is occurring or a severity level of the impact. The processing unit may further be configured to analyze the received sensor data, the determined object type, and/or the determined severity level in order to determine one or more appropriate actions to take in response to the detected impact.

### CROSS-REFERENCE TO RELATED APPLICATIONS

This application claims the benefit of and priority to U.S. Provisional Application No. 62/577,341 entitled “DYNAMIC IMPACT DETECTION” filed on Oct. 26, 2017, the entire contents of which is incorporated by reference herein in its entirety.

### BACKGROUND

After being used in military application for some time, so called “drones” have experienced a significant increase in public use and interest in recent years. The proposed uses for drones has rapidly expanded to include everything from package delivery to mapping and surveillance. The wide-ranging uses for drones has also created a wide assortment of different drone configurations and models. For example, some drones are physically better suited to travelling at high speed, while other drones are physically better suited for travelling long distances.

Conventional drones typically fall within two different categories: fixed-wing drones and rotor-based drones. Rotor-based drones may comprise any number of different rotors, but a common rotor configuration comprises four separate rotors. Rotor-based drones provide several benefits over fixed-wing drones. For example, rotor-based drones do not require a runway to take-off and land. Additionally, rotor-based drones can hover over a position, and in general are typically more maneuverable. Also, rotor-based drones are significantly more capable of flying within buildings and other structures.

Despite these advantages, several technical limitations have slowed the wide-spread use and adoption of rotor-based drones. One such technical limitation relates to detecting and responding to impacts of the rotor-based drones with environmental obstacles. For example, a rotor-based drone may collide with a tree branch. The collision with the tree branch, or even small leaves on a tree branch, can cause significant damage to rotors on the rotor-based drone. The damaged rotors can impact the flight dynamics of the rotor-based drone to the point of causing the rotor-based drone to crash. One will appreciate that such collisions are not uncommon and that the resulting damage can be significant. Accordingly, there is a need in the field for technical solutions for detecting and responding to impacts of the rotor-based drones with environmental obstacles.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein comprise systems, methods, and apparatus configured to dynamically detect and respond to impacts with objects in the flight path of rotor-based drones. In particular, disclosed embodiments comprise rotor-based drones that include various sensors that are capable of generating data associated with impacts occurring in-flight. The rotor-based drones are further configured to characterize a given impact, including identifying an object or object type with which the vehicle has made contact and/or a severity level associated with the impact. The rotor-based remote flying vehicle is further configured to analyze any combination of the received sensor data, the identified object, and/or the identified severity level, in order to determine an appropriate action to take in response to the detected impact.

In at least one embodiment, a system for dynamically detecting rotor impacts comprises a drone body with one or more attached modular arms. The system also comprises the one or more attached modular arms each comprising a motor. Each motor comprises a rotor. A microphone is embedded within at least one of the one or more attached modular arms. The microphone is configured to detect audio sound waves generated by the impact of the rotor.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings which are listed below.

FIG. 1 illustrates an embodiment of a quadrotor.

FIG. 2A illustrates an embodiment of a rotor impact.

FIG. 2B illustrates another embodiment of a rotor impact.

FIG. 2C illustrates another embodiment of a rotor impact.

FIG. 3 illustrates a flowchart for an embodiment of a method for dynamically detecting impact of a rotor.

### DETAILED DESCRIPTION

Disclosed embodiments extend to systems, methods, and apparatus configured to dynamically detect and respond to impacts with environmental obstacles. In at least one embodiment, environmental obstacles comprise objects in the flight path of rotor-based drones. In particular, disclosed embodiments comprise rotor-based drones that include various sensors that are capable of generating data associated with impacts occurring in-flight. The rotor-based drones are further configured to characterize a given impact, including identifying an object or object type with which the vehicle has made contact and/or a severity level associated with the impact. The rotor-based remote flying vehicle is further configured to analyze any combination of the received sensor data, the identified object, and/or the identified severity level, in order to determine an appropriate action to take in response to the detected impact.

In the following disclosure, various exemplary embodiments of the present invention are recited. One will understand that these examples are provided only for the sake of clarity and explanation and do not limit or otherwise confine the invention to the disclosed examples. Additionally, one or more of the following examples is provided with respect to a “quadrotor.” One will understand that the usage of a “quadrotor” is merely for the sake of clarity and that the present invention applies equally to all rotor-based remote flying vehicle platforms regardless of the number of rotors.

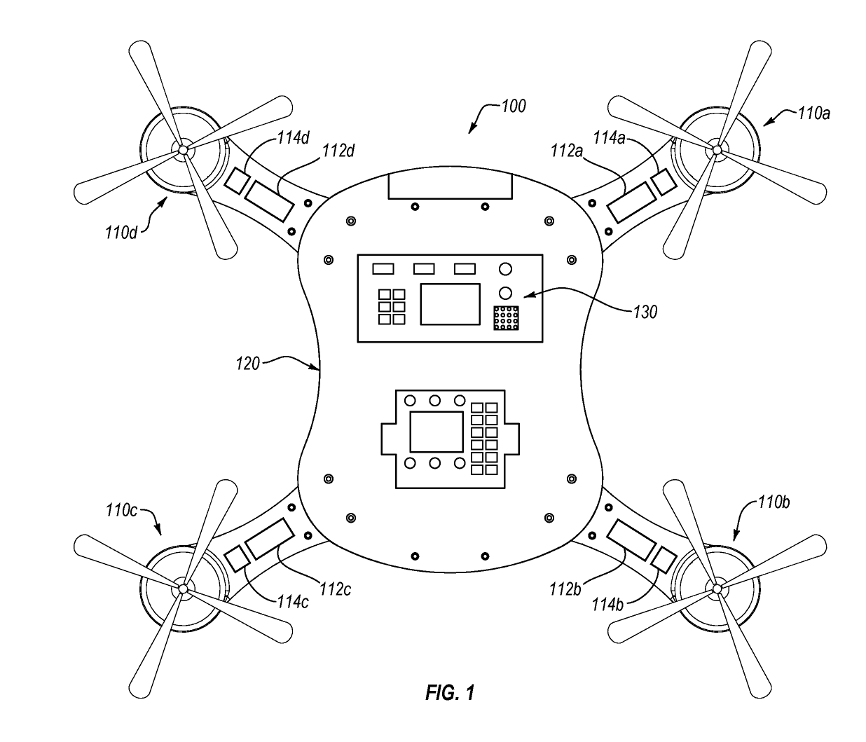

Turning to the figures, FIG. 1 illustrates a quadrotor 100 that comprises multiple arms 110(a-d) attached to a vehicle body 120. Notably, in some embodiments, the arms 110(a-d) comprise modular arms, such that different types of arms (e.g., arms of different lengths, arms of different materials, arms having different types of rotors, and so forth) are selectively removable and reconfigurable. Additionally, as illustrated in FIG. 1, each arm may include a camera 112 (i.e., camera 112a through camera 112d) and a microphone 114 (i.e., microphone 114a through microphone 114d). Notably, while each arm 110 is illustrated as having a camera 112 and a microphone 114, in other embodiments the quadrotor 100 may have less than four cameras or less than four microphones. For instance, there may only be one camera that is located in a more central location of the quadrotor 100. The camera(s) 112 and the microphone(s) 114 may be particularly configured to aid in detecting impact that has been made by any part of the quadrotor 100 with an object located within a flight path of the quadrotor, as further described herein.

The depicted quadrotor 100 also comprises a processing unit in the form of flight control unit 130 within the vehicle body 120. The flight control unit 130 comprises sensors for controlling the quadrotor (e.g., altimeter, gyroscopes, GPS, sonar, etc.), along with various control and processing modules (e.g., CPU, radio, antenna, GPU, etc.) In at least one additional or alternative embodiment, the flight control unit 130 and/or associated sensors are otherwise located or dispersed through the quadrotor 100. As such, the flight control unit may receive sensor data (e.g., related to impact detection, position, speed, battery power, and so forth) and provide flight controls based upon the received positional sensor data.

In at least one embodiment, the flight control unit 130 receives data from gyroscopes and accelerometers. Such data may relate to collisions or contact made with objects within the flight path of the quadrotor 100. Using the received sensor information, the flight control unit controls the flight of the quadrotor using a control system, such as a PID loop. For example, the flight control unit 130 may be configured to adjust various flight characteristics (e.g., flight direction, rotations per minute (RPM) of one or more rotors of the quadrotor, and so forth) based on determining, via received sensor information, that one or more rotors of the quadrotor has made contact within an object.

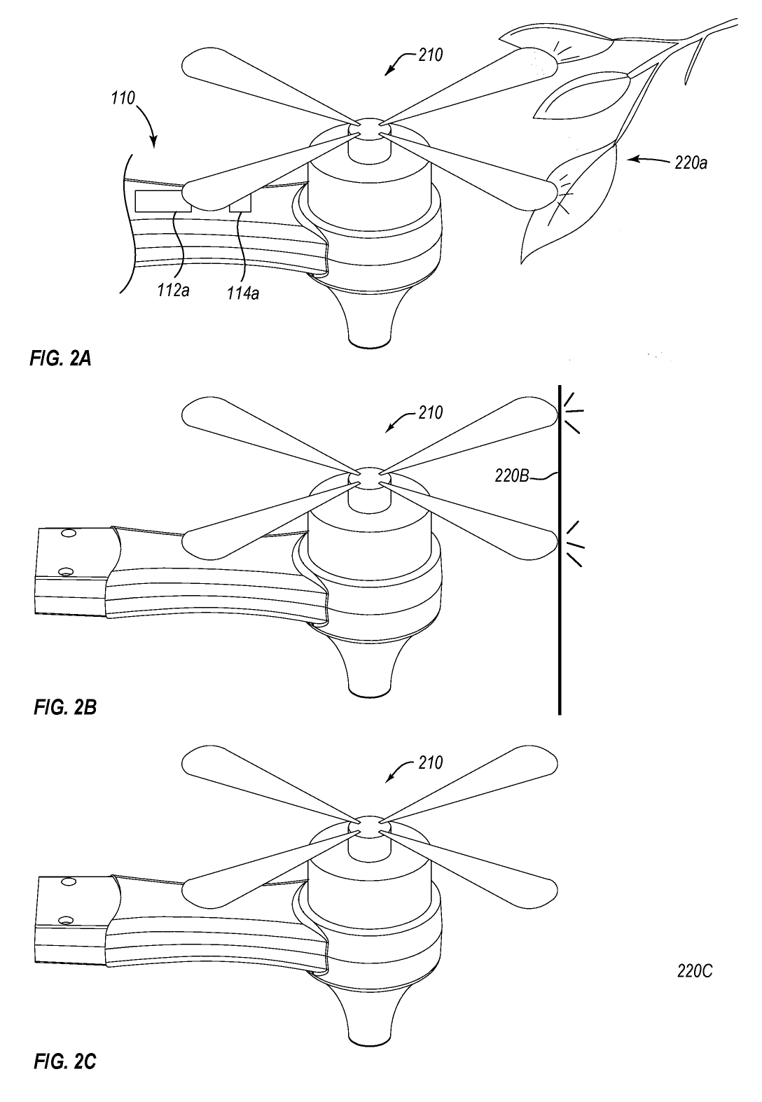

Accordingly, in at least one embodiment of the present invention, the quadrotor 100 may be configured to dynamically identify when an impact with an object has occurred. In an example, FIG. 2A illustrates a modular arm 110a with a rotor 210 that is colliding with leaves of tree 220A. In such an example, a microphone 114a, a camera 112a, an accelerometer (not shown), a gyroscope (not shown), and so forth may each be configured to send, to the flight control unit, sensor data associated with making contact with the tree 220A. For instance, the sensor data may comprise sound data sent from the microphone 114a that receives sounds waves made while the rotor(s) 210 is making contact with the tree 220a. Sensor data may also be sent by one the of the various sensors regarding a change in RPM's associated with the impact (e.g., from an electronic speed control), a change in voltage/current in various parts (e.g., from an electronic speed control or other microcontroller) of the quadrotor 100, positioning data (e.g., from the gyroscope/accelerometer or GPS), acceleration data, and so forth.

The flight control unit 130 may then be capable of analyzing the received sensor data to identify a type of impact that has occurred. In some embodiments, the flight control unit 130 may be capable of identifying a type of impact based only on one type of received sensor data. For instance, the flight control unit 130 may identify a type of impact based on sound data received. Using the current example of FIG. 2A, the flight control unit 130 may analyze received sound data to determine that contact is currently being made with leaves of a tree 220a (or alternatively, that contact is currently being made with a trunk of a tree 220a).

Alternatively, the flight control unit 130 may analyze a combination of sensor data to determine a type of impact. More specifically, again using the current example of FIG. 2A, the flight control unit may analyze received data associated with sound, RPM changes, electrical (i.e., voltage/current) changes, positional changes, acceleration changes, and so forth, to identify that contact is currently being made with leaves of a tree 220a. Accordingly, an identification of an impact may further comprise an identification of the object or type of object with which impact has occurred (e.g., leaves, a tree trunk, and so forth).

In at least one embodiment, the determination of the type of impact and/or the object impacted is performed based upon previously generated impact fingerprints. As used herein, an impact fingerprint comprises characteristics of one or more previously recorded impacts of a known severity and/or known type. For example, a quadrotor 100 may be intentionally flown into leaves. The microphone 114 may detect a particular amplitude and frequency of sound generated by a rotor hitting the leaves. Similarly, the camera 112 may gather image data that is specific to leaves. The sensor data generated by the impact can then be manually categorized by a user based upon severity of impact and/or impact object.

This same process can be performed multiple different times with the same objects and same severity or with different objects and different severities. The resulting data is then processed to create various impact fingerprints that are associated with different severities and/or types of objects. The impact fingerprints are stored within a database that is local to the quadrotor 100 or remotely accessible by the quadrotor 100.

Accordingly, when a quadrotor 100 impacts an unknown object during flight, the sensor data that is gathered by the sensors (e.g., 112, 114) is automatically compared to the impact fingerprints within the local or remote database. The comparison of the sensor data to the impact fingerprints may utilize a probabilistic analysis and/or a neural network, or some other machine learning system, that learns to match the sensor data to the impact fingerprints. Further, over time, the impact fingerprints may be updated to include additional characteristics of impacts that are identified based upon the current impact fingerprints.

FIG. 2B illustrates another example of the rotor 210 making contact with an object. In particular, FIG. 2B illustrates the rotor making contact with a wall 220B. Again, the flight control unit may analyze any combination of received data (e.g., sound, RPM changes, and so forth) to determine the severity of the impact of the rotor 210 against the solid object (i.e., the wall 220B). FIG. 2C illustrates the rotor 210 meeting resistance associated with wind 220C. Yet again, the flight control unit may analyze any combination of received sensor data (e.g., sound, RPM changes, and so forth) to determine that the rotor 210 is experiencing air resistance (i.e., as shown by wind 220C) rather than having made contact with a particular object.

In at least one embodiment, the flight control unit 130 analyzes the sensor data to identify the severity of the impact (e.g., high severity, medium severity, low severity) and the type of object impacted (e.g., solid object, non-solid object). The impact fingerprints stored within the database comprise characteristics that distinguish an impact with a solid object (e.g., wall 220B) with an impact of a non-solid object (e.g., leaves 220A or wind 220C). For example, an impact with a solid object may produce a more consistent, higher frequency audio wave than an impact with a non-solid object. Similarly, an impact with a solid object may produce a more consistent images from a camera than an impact with a non-solid object where the camera may capture the object moving in response to the impact.

While only three example types of impacts are illustrated in FIGS. 2A through 2C, the principles described herein may be practiced with respect to essentially any type of impact. Additionally, while the examples of FIG. 2A through FIG. 2C illustrate an impact with only one rotor of quadrotor 100, impact may take place with respect to any number of the rotors. As such, the principles described herein may be practiced when any number of rotors are experiencing an impact with an object.

Similarly, while the above examples have been primarily based upon sensor data received from a microphone 114 and a camera 112, in at least one embodiment, any number of other additional sensor types can be used to the same effect. For example, at least one embodiment may utilize one or more of a sonar, a radar, a lidar, a laser range finger, an altimeter, an accelerometer, or any number of other sensors. Each of these types of sensors can be used to create impact fingerprints based on different impact objects and/or impact severities.

As explained above, in at least one embodiment, an identification of the type of impact may also include a determination of a severity level associated with the type of impact. Such a severity level may correspond solely to an impact object type, solely to received sensor data (e.g., speed, sound, acceleration, and so forth), or a combination of the determined impact object type and the received sensor data. For instance, a high severity level may correspond to a detected impact with solid objects (e.g., walls, buildings, windows, fences, and so forth), while lower severity levels (e.g., low and/or medium) may correspond to a detected impact with non-solid objects (e.g., leaves, bugs, air resistance, and so forth). In contrast, in at least one embodiment, an impact with leaves may correspond with a high severity impact if the leaves have a significant impact on the drone, as detected by the various sensors.

Using FIGS. 2A through 2C as examples, detection of an impact with leaves of the tree 220A in FIG. 2A and detection of air resistance in FIG. 2C may result in a determination of a low severity level, while detection of an impact with the wall 220B of FIG. 2B may result in a high severity level. In another example, assuming that rather than making contact with leaves of the tree 220A, the rotor 210 has made contact with a trunk of the tree, a high severity level would likely be determined. Accordingly, the flight control unit 130 may analyze received sensor data to determine a type of impact, which may include a categorization of the impact that comprises either or both of an impact object type with which contact has been made and a severity level associated with the detected impact/detected impact object.

As implied, in some embodiments, detected object types and/or received sensor data may be mapped to particular severity levels, such that upon receiving particular sensor data and/or determining an impact object type (e.g., leaves), the flight control unit may immediately identify a severity level. In other embodiments, the flight control unit may dynamically determine an impact object type and a severity level to be associated with the object type based on received sensor data.

In at least one embodiment, the impact severity may be determined based upon information receives from an IMU (inertial measurement unit). For example, a severe impact may be associated with high inertial force, whereas a low severity impact may register a low inertial force. Similarly, rotational information (e.g., RPMs) information from an electronic speed control may also be used to indicate the severity of the impact. An impact that causes the RPMs of a rotor to drop a threshold amount may be categorized as a high severity impact.

Based on the type of impact identified (e.g., type of object, severity level, and so forth), the flight control unit 130 may further be capable of determining an appropriate action to take. For instance, the flight control unit may determine that an optimal action to take in response to a particular impact comprises an increase in RPM's, a reduction in RPM's, a change in flight path, cutting the motor entirely, and so forth. Notably, the possible actions enumerated herein are only used for exemplary purposes. As such, any number of possible actions may be taken in response to a detected impact. In a particular example using FIG. 2A, the flight control unit may first identify that one or more rotors (e.g., rotor 210) have made contact with an object during flight. Based on received sensor data (e.g., sound, RPM change, and so forth), the flight control unit may further determine a type of object with which contact has been made.

In the continuing example of FIG. 2A, the flight control unit may determine that one or more rotors have contacted a non-solid object, or, in at least one embodiment, more specifically that the rotors have impacted leaves of the tree 220A. Optionally, the flight control unit 130 may also determine a severity level associated with the determined object type of the identified impact. Based on determining that the impact object type comprises leaves of a tree, the flight control unit may determine that the severity level is medium or low. Regardless of whether a severity level is determined, the flight control unit may determine an appropriate action to take in response to the detected impact.

For example, in FIG. 2A, the flight control unit 130 has determined that contact has been made with leaves on a tree 220A. In response to this determination, the flight control unit 130 may determine that an appropriate action would be to increase RPM's of one or more rotors to cut through the leaves. Alternatively, the flight control unit 130 may determine that the appropriate action is to change the flight path and steer the quadrotor 100 away from the leaves on the tree 220A.

In another example, the flight control unit 130 may determine that impact has been made with a solid object (e.g., a wall 220B in FIG. 2B) based on received sensor data. In such an example, the flight control unit 130 may determine that an appropriate action comprises shutting off the motor 210 entirely. The remaining active motors can then quickly move the quadrotor 100 away from the wall 200B or guide the quadrotor 100 through an emergency landing process. Alternatively, the flight control unit 130 may determine that the appropriate action is to change the flight path and steer the quadrotor 100 away from the leaves on the wall 220B.

Notably, the flight control unit 130 may dynamically determine an appropriate action to take in response to determining an impact object type and/or a severity level based on received sensor data. For example, the flight control unit 130 may account for remaining power available to the quadrotor 100. In the case that power levels (e.g., battery levels) are low, the flight control unit 130 may dynamically initiate an emergency landing process for any level of impact. In contrast, if power levels are high, the flight control unit 130 may increase the speed of a motor 210 in response to a low severity level of impact. The increased speed may draw more power, but the increased speed may also counteract the low-level severity impact. In additional or alternative embodiments, the flight control unit 130 may dynamically adjust responses based upon the number of motors 210 that are being impacted, the altitude of the quadrotor 100 at the time of the impact, the speed of the rotors at the time of the impacts, or any number of other considerations.

Alternatively, detected object types or severity levels may be mapped to particular actions, such that upon determining an impact object type (e.g., leaves) and/or severity level, the flight control unit may immediately identify an appropriate action to take based on the mapping. Accordingly, in at least one embodiment, the flight control unit 130 comprises a database, or has access to a remote database, of information relating to potential received sensor data, detected impact objects, and determined severity levels, as well as appropriate actions to take in response to such sensor data, impact objects, and severity levels. In particular, the database may comprise numerous mappings (also referred to herein as “impact fingerprints”). For instance, particular sensor data (e.g., sound, video, images, RPM changes, electrical changes, positional changes, and so forth), or combinations of sensor data, may be mapped to particular impact objects (e.g., leaves, trees, walls, windows, and so forth) and/or severity levels. The database may also include mappings of impact objects to severity levels, as well as mappings of sensor data, impact objects, and/or severity levels to appropriate actions to take in response.

Accordingly, the flight control unit may be pre-programmed or pre-trained with respect to many different types of received sensor data, impact object types, severity levels, and appropriate actions to take in response to such sensor data, impact object types, and severity levels. Additionally, the flight control unit may employ machine learning, such that the flight control unit can continually improve detection of object types, severity levels, and appropriate actions to take, based on previous experiences.

Notably, as stated above, one will understand that the depicted quadrotor 100 is merely exemplary. Additional or alternate embodiments of the present invention may comprise rotor-based remote flight systems with less than four arms 110(a-d) or rotor-based remote flight systems with more than four arms 110(a-d). Additionally, various embodiments of the present invention may comprise different physical configurations, construction materials, proportions, and functional components. For instance, rotor-based remote flight platforms may comprise a mixture of components such as cameras, sonars, laser sights, GPS, various different communication systems, and other such variations. Accordingly, the principles described herein may be practiced using essentially any configuration of sensors with respect to any configuration of rotor-based flight systems.

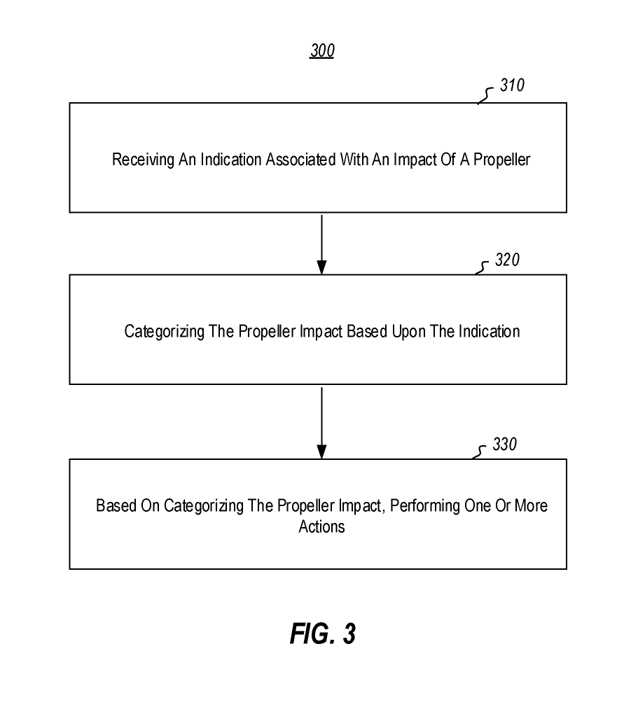

One will appreciate that embodiments disclosed herein can also be described in terms of flowcharts comprising one or more acts for accomplishing a particular result. For example, FIG. 3 and the corresponding text describe acts in various methods and systems for dynamically detecting a rotor impact and determining an appropriate response. The method 300 is described with frequent reference to FIG. 1 through FIG. 2C.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

The method 300 includes receiving an indication associated with an impact of a rotor (Act 310). For instance, the flight control unit 130 may receive sensor data (e.g., sound, RPM changes, and so forth) associated with a rotor (e.g., the rotor 210) impact from one or more sensors of the quadrotor 100. The method 300 may further include categorizing the rotor impact based upon the indication (Act 320). For example, based on the received sensor data, the flight control unit may determine either or both of an impact object type (e.g., leaves, a tree trunk, a wall, and so forth) and a severity level (e.g., high, medium, or low). The method 300 may also include, based on categorizing the rotor impact, performing one or more actions (Act 330). For instance, based on determining that a detected impact comprises contact made with a particular object/object type or a particular severity level, one or more appropriate actions (e.g., change RPM's, change flight path, and so forth) to take in response may be determined.

In this way, a quadrotor (or other flight-based system) may dynamically detect impacts of one or more rotors of the quadrotor with one or more objects. More specifically, the quadrotor may have multiple sensors that are capable of generating data associated with impacts of the quadrotor. Based on the received data, the quadrotor may categorize the impact based on an object (or type of object) with which the quadrotor has made contact or a severity level. Using a combination of the received sensor data, the determined object type, and/or the determined severity level, quadrotor may dynamically and intelligently determine an appropriate action to take in response.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for dynamically detecting rotor impacts comprising:
receiving, from a sensor positioned on a drone, an indication associated with an impact of a rotor;
categorizing the impact of the rotor based upon the indication; and
based on categorizing the impact of the rotor, performing one or more actions.

2. The method of claim 1, wherein the indication of rotor impact comprises sensor data.

3. The method of claim 2, wherein the sensor data comprises sound data associated with a sound of the impact.

4. The method of claim 2, wherein the sensor data comprises rotor data associated with a change in rotations per minute (RPM) of the rotor.

5. The method of claim 2, wherein categorizing the rotor impact comprises mapping sensor data to an impact fingerprint.

6. The method of claim 1, wherein categorizing the rotor impact comprises determining at least one of an object type or a severity level.

7. The method of claim 1, wherein performing one or more actions comprises adjusting one or more motor characteristics.

8. The method of claim 7, wherein performing one or more actions comprises initiating an emergency landing process.

9. The method of claim 7, wherein performing one or more actions comprises moving the drone away from the object.

10. A system for dynamically detecting rotor impacts, the system comprising:
one or more processors; and
one or more computer-readable media having stored thereon executable instructions that when executed by the one or more processors configure the computer system to perform at least the following:
receive, from a sensor positioned on a drone, an indication associated with an impact of a rotor;
categorize the impact of the rotor based upon the indication; and
based on categorizing the impact of the rotor, perform one or more actions.

11. The system of claim 10, wherein the indication of rotor impact comprises sensor data.

12. The system of claim 11, wherein the sensor data comprises sound data associated with a sound of the impact.

13. The system of claim 11, wherein the sensor data comprises rotor data associated with a change in rotations per minute (RPM) of the rotor.

14. The system of claim 11, wherein categorizing the rotor impact comprises mapping sensor data to an impact fingerprint.

15. The system of claim 10, wherein categorizing the rotor impact comprises determining at least one of an object type or a severity level.

16. The system of claim 10, wherein performing one or more actions comprises adjusting one or more motor characteristics.

17. The system of claim 16, wherein performing one or more actions comprises initiating an emergency landing process.

18. The system of claim 16, wherein performing one or more actions comprises moving the drone away from the object.

19. The system of claim 10, further comprising:
a microphone embedded within a modular arm of the drone, wherein the microphone is configured to detect audio sound waves generated by the impact of the rotor.

20. A system for dynamically detecting rotor impacts, the system comprising:
a drone body with one or more attached modular arms;
the one or more attached modular arms each comprising a motor;
each motor comprising a rotor; and
a microphone embedded within at least one of the one or more attached modular arms, wherein the microphone is configured to detect audio sound waves generated by the impact of the rotor.
